(19) United States
(12) Patent Application Publication
(10) Pub. No.: US 2006/0220521 A1
(43) Pub. Date: Oct. 5, 2006

(54) Electrode structure

(75) Inventors: Jer-Shien Yang, HsinChuang City (TW); Yen-Shan Chuang, HsinChu (TW); Jen-Shou Cheng, HsinChu Hsien (TW); Yui-Shin Fran, HsinChu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Optoelectronics, Inc., HsinChu (TW)

(21) Appl. No.: 11/353,791

(22) Filed: Feb. 14, 2006

(30) Foreign Application Priority Data
Apr. 4, 2005 (TW) 094110782

(51) Int. Cl. H01J 63/04; H01J 1/62

(52) U.S. Cl. 313/491; 313/493

(57) ABSTRACT

An electrode structure is provided. The electrode structure contains a first auxiliary electrode and a second auxiliary electrode, a first edge electrode and a second edge electrode disposed between the first auxiliary electrode and the second auxiliary electrode, wherein the first edge electrode forming an electrode pair with the first auxiliary electrode and having a same polarity as that of the first auxiliary electrode and the second edge electrode forming an electrode pair with the second auxiliary electrode and having a same polarity as that of the second auxiliary electrode, and at least one middle electrode disposed between the first edge electrode and the second edge electrode. The electrode structure respectively enhance an interaction between the first edge electrode and the second edge electrode and a neighboring electrode by means of the first auxiliary electrode and the second auxiliary electrode. Alternatively, the width of the edge electrode increase to be 1.5 to 4 times of its original value in order to increase the current density on the edge electrode and to increase the brightness of the edge discharging zone so that the brightness difference between the middle zone and the edge zone is not great.

### FIELD OF THE INVENTION

The present invention relates to an electrode structure, and more particularly, to an electrode structure for, but not limiting to, a backlight of a liquid crystal display. The electrode structure can be used in application fields of flat fluorescent lamp, such as advertising illumination, indicating and emergence illumination.

### BACKGROUND OF THE INVENTION

Recently, because the manufacturing techniques of LCDs (liquid crystal display) become more and more mature and many efforts of research and development are aggressively made by LCD companies all over the world to use large scale manufacturing equipments, quality of the produced LCD becomes more and more advanced. Among LCD products, LCD TV (liquid crystal display television) is a promising and interesting product. The use and application of digital televisions become popular and universal, and the LCD TV has become a main subject when the television era changes from CRT television to LCD TV.

Conventionally, the LCD is the display system which can not emit light by itself. A backlight is used to be a source of light. The well-known light source structure is the backlight module containing several individual cold cathode fluorescence lamps (CCFL). The other improved backlight structure concerns a flat lamp as the backlight of an LCD display.

Please refer to FIG. 1 which shows a schematic view of a cold cathode flat fluorescent lamp (CCFFL). The cold cathode flat fluorescent lamp 10 contains a upper glass substrate 11, a lower glass substrate 12, metal electrodes 13 and 14 and inert gas (not shown) in the lamp. It shall be noted that the metal electrode 13 and 14 may be put on the same outside wall of the lamp body to form an outside-electrode cold cathode flat fluorescent lamp.

The illuminating principle of the cold cathode flat fluorescent lamp is that a voltage is applied across the metal electrodes 13 and 14 in order to render the electrodes to emit or absorb electrons. The electrons will collide molecules of the inert gas in the lamp and the gas molecules are excited to a plasma state. When the excited gas molecules return to a ground state, ultraviolet rays are generated. The ultraviolet rays will excite fluorescence powder beneath an inner wall of the lamp to emit visible light.

From the illuminating theory of the cold cathode flat fluorescent lamp, it is known that the design pattern of the metal electrodes 13 and 14 will greatly affects light-emitting performance of the cold cathode flat fluorescent lamp 10.

Please refer to FIG. 2(a), which is a top view of a first electrode structure of the conventional cathode flat fluorescent lamp. In FIG. 2(a), the metal electrodes 13 and 14 are electrodes having opposite polarities. For the metal electrode 13, several pairs of electrode pairs 131 and 132 are disposed in the middle part of the lamp surface. In the same way, for the metal electrode 14, several pairs of electrode pairs 141 and 142 are disposed on the middle part of the lamp surface. The adjacent electrodes 132 and 141 will generate the gas discharge phenomenon because they have different opposite polarities. To be different, an edge electrode 133 or 134 is needed to be mounted at both ends of the lamp surface but no electrode having opposite polarity exists at the outside. They all belong to the metal electrode 13 for demonstrating the edge electrodes. Certainly, the edge electrodes 133 and 134 at both ends of the lamp surface may have different polarities. As shown in FIG. 2(b), the edge electrode 133 belongs to the metal electrode 13 and the edge electrode 134 belongs to the metal electrode 14, while the arrangement of the edge electrodes is dependent upon the design way of the lamp.

FIGS. 2(c) and 2(d) are respectively top views of the third and fourth electrode structures of conventional cold cathode flat fluorescent lamps. The difference between FIG. 2(c) and FIG. 2(a) is that in FIG. 2(c), the electrode pairs having same polarity do not exist in the middle electrode area between the edge electrode 133 and the edge electrode 134. When the gas discharging is carried out, the electrode 141 will interact with the edge electrode 133 and the electrode 131 as shown in FIG. 2(c), and the electrode 131 will interact with electrodes 141, 142. Compared to FIG. 2(a), the similarity is that the gas discharging occurs at the left and right edges. In the same way, the difference between FIG. 2(d) and FIG. 2(b) is the same as that between FIG. 2(c) and FIG. 2(a).

However, at the two ends of the lamp surface, the light intensity and brightness is not strong enough because at the two ends only one side discharge will happen in view of the design way of the 4 kinds of electrode structures and their discharging performance. For example, when a 7 inch flat fluorescent lamp is lit, a drawing showing the distribution of lighting intensity is demonstrated in FIG. 3. From FIG. 3, the brightness at the middle part is 4010 nits while the brightness at the end is 3230 nits, which generating the phenomenon of an edge dark zone in a flat fluorescence lamp. In particular, the edge dark zone phenomenon for a backlight module of a flat fluorescence lamp does not meet the specifications required by the customer.

The brightness at the discharging zone at both ends of the flat fluorescence lamp is weak. It is inferred that the electrical field and current density at the both ends are weaker than those in the middle of the lamp. The electrode structure of FIG. 2(a) is exemplified (and so for FIG. 3), and the electrode 132 or 142 is respectively disposed on one side of the electrode 131 or 141 with the same polarity. The gas discharging occurs at both sides of each electrode pair. Only a single electrode exists as an edge electrode 133 or 134 at the outer side of the electrode pair and discharges at one side. Although the gas discharging phenomenon is related to electrodes having opposite polarities and not related to adjacent electrodes having same polarity, those skilled in the art of working principle of the flat fluorescence lamp know that the existence of an adjacent electrode having a same polarity will affect the electrical field and current density of an electrode to some extent. Therefore, the electrical field and current density of an edge electrode 133 or 134 will differ from those of the middle electrodes in the middle of the lamp surface because the edge electrode 133 or 134 does not have the other electrode having a same polarity and discharges at the other side, thereby generating the so-called edge dark zone.

In order to resolve the edge dark zone problem, researchers have attempted to modify the design of the whole electrode to position it closer to the edge of the lamp body so as to increase discharging distance and to increase the brightness. But, because at both ends of the lamp body the light-emitting zone essentially has a brightness lower than that in the middle of the lamp body, to change the position of the electrode will not improve the brightness of the edge dark zone. It is inferred that at the edge dark zone, the distribution of the electrical field and current density at both ends of the lamp body are different from those in the middle of the lamp body. The inventor tried to modify the design way of the edge electrodes at both ends of the lamp body.

### SUMMARY OF THE INVENTION

According to an aspect of the present invention, the present invention is to increase light-generating efficiency of a cold cathode flat fluorescence lamp and to improve a dark zone phenomenon rendered by electrodes at two ends of the lamp surface.

According to another aspect of the present invention, the present invention is to solve a problem saying that the edge electrodes at two ends of the conventional cold cathode flat fluorescence lamp merely discharged at one side of the edge electrode, which results in that distribution of the electrical field and current density near the edge electrode is different from that in the middle of the lamp and that light brightness at the ends of the lamp surface is insufficient compared to that in the middle of the lamp surface.

According to another aspect of the present invention, the gist of the present invention is that an auxiliary electrode is respectively disposed at the outside of the edge electrode at two ends of the cold cathode flat fluorescence lamp and the auxiliary electrode has a same polarity as that of the edge electrode. The auxiliary electrode does not involve in gas discharging of the flat fluorescence lamp and is used to increase the electrical field and current density near the edge electrode, in order to increase the light brightness incurred by the gas discharging of the edge electrode and to compensate the edge dark zone phenomenon at two ends of the lamp surface and to make the two ends of the lamp surface substantially have same electrical field and current density and light brightness as those in the middle of the lamp surface.

According to another aspect of the present invention, the width of the edge electrode increases to be 1.5-4 times of the width of the original edge electrode. In this way, the current density near the edge electrode increases and the brightness at the ends of the cold cathode flat fluorescence lamp increases to be the same as that in the middle of the lamp.

According to the another aspect of the present invention, while an auxiliary electrode is respectively disposed at the outside of the edge electrode at two ends of the cold cathode flat fluorescence lamp, by suitably regulating the width of the auxiliary electrode and by changing the adjustable distance between the auxiliary electrode and the edge electrode, the brightness at the ends of the lamp surface changes. The adjustable distance between the auxiliary electrode and the edge electrode is in reverse proportion to the brightness at the ends of the lamp surface. That is to say, when the distance between the auxiliary electrode and the edge electrode is longer, the effect that the auxiliary electrode will affect the gas discharging of the edge electrode is weaker and the brightness near the ends is lower. On the contrary, when the distance between the auxiliary electrode and the edge electrode is shorter, the effect that the auxiliary electrode will affect the gas discharging of the edge electrode is stronger and the brightness near the ends is higher. The alternative method is to regulate the width of the edge electrode to change the current density on the edge electrode. When the width becomes 1.5 times of the original one, the increasing amount of the current density becomes smaller so that the increasing amount of the brightness becomes smaller. To the contrary, when the width becomes 4 times of the original one, the increasing amounts of the brightness and current density becomes larger.

According to another aspect of the present invention, the present invention is to provide a large scale cold cathode flat fluorescence lamp by combining a plurality of the above cold cathode flat fluorescence lamps. A large scale cold cathode flat fluorescence lamp having homogeneous high brightness is obtained by the arrangement of the auxiliary electrodes, the regulation of the width of the auxiliary electrodes to change the distance between the auxiliary electrode and the edge electrode and the changing of the increasing amount of the width of the electrodes, in order to control the brightness at the interface between different adjacent cold cathode flat fluorescence lamps.

According to another aspect of the present invention, the present invention is to provide an electrode structure comprising:
a first auxiliary electrode and a second auxiliary electrode; and
a first edge electrode and a second edge electrode disposed between the first auxiliary electrode and the second auxiliary electrode, wherein the first edge electrode and the first auxiliary electrode form a first electrode pair and have the same polarity, and the second edge electrode and the second auxiliary electrode form a second electrode pair and have the same polarity;

wherein an interaction between the first edge electrode and the second edge electrode and a neighboring electrode thereof is enhanced by means of the first auxiliary electrode and the second auxiliary electrode.

Preferably, a first adjustable distance exists between the first auxiliary electrode and the first edge electrode, and a second adjustable distance exists between the second auxiliary electrode and the second edge electrode.

Preferably, the amounts of the first adjustable distance and the second adjustable distance determine a strength of the interaction.

Preferably, the first edge electrode is located with a first electrode width which determines a strength of the interaction.

Preferably, the first auxiliary electrode is located with a second electrode width which is 1.5-4 times of the first electrode width.

Preferably, the electrode structure further comprises at least one middle electrode disposed between the first edge electrode and the second edge electrode.

Preferably, the electrode structure further comprises plural middle electrodes, the plural middle electrodes form a plurality of electrode pairs.

Preferably, each of the plurality of electrode pairs is formed from two middle electrodes having a same polarity, and two adjacent electrode pairs have the opposite polarities.

Preferably, when an amount of the electrode pairs is odd, the first edge electrode and the second edge electrode have a same polarity.

Preferably, when an amount of the electrode pairs is even, the first edge electrode and the second edge electrode have an opposite polarity.

Preferably, each of the plural middle electrodes is a single electrode, and adjacent middle electrodes thereof have opposite polarities.

According to another aspect of the present invention, the present invention provides a cold cathode flat fluorescent lamp comprising the above electrode structure.

Preferably, the interaction is a gas discharging effect.

According to another aspect of the present invention, the present invention provide a large scale cold cathode flat fluorescent lamp comprising the above plural cold cathode flat fluorescent lamps.

The foregoing and other features and advantages of the present invention will be more clearly understood through the following descriptions with reference to the drawings, wherein:

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The color drawings are FIGS. 3, 8(a), 8(c), 9(a), 9(b), 10(a), and 10(b).

FIG. 1 is a three-dimensional schematic view showing a conventional cold cathode flat fluorescence lamp;

FIG. 2(a)-2(d) are top views showing the first to fourth electrode structures of conventional cold cathode flat fluorescence lamps;

FIG. 3 is a schematic view showing brightness distribution of a conventional 7 inch flat fluorescence lamp;

FIG. 4 is a top view showing a embodiment of the auxiliary electrode of the electrode structure according to the present invention;

FIG. 5 is a top view showing another embodiment of the auxiliary electrode of the electrode structure according to the present invention;

FIG. 6 is a top view showing a embodiment of the edge electrode having a broadened width of the electrode structure according to the present invention;

FIG. 7 is a top view showing another embodiment of the edge electrode having a broadened width of the electrode structure according to the present invention;

FIG. 8(a) is an electrical field simulation diagram showing an electrode structure without auxiliary electrodes according to prior art;

FIG. 8(b) is an electrical field simulation diagram showing an electrode structure with auxiliary electrodes according to the present invention;

FIG. 8(c) is an electrical field simulation diagram showing a comparison between the electrode structure of FIG. 2(a) and the electrode structure of FIG. 4.

FIG. 9(a) is a lighting status diagram of a conventional 7 inch flat fluorescence lamp with a diffuse plate and diffuser;

FIG. 9(b) is a brightness distribution diagram of a conventional 7 inch flat fluorescence lamp with a diffuse plate and diffuser;

FIG. 10(a) is a lighting status diagram of a 7 inch flat fluorescence lamp with a diffuse plate and diffuser according to the present invention; and

FIG. 10(b) is a brightness distribution diagram of a 7 inch flat fluorescence lamp with a diffuse plate and diffuser according to the present invention.

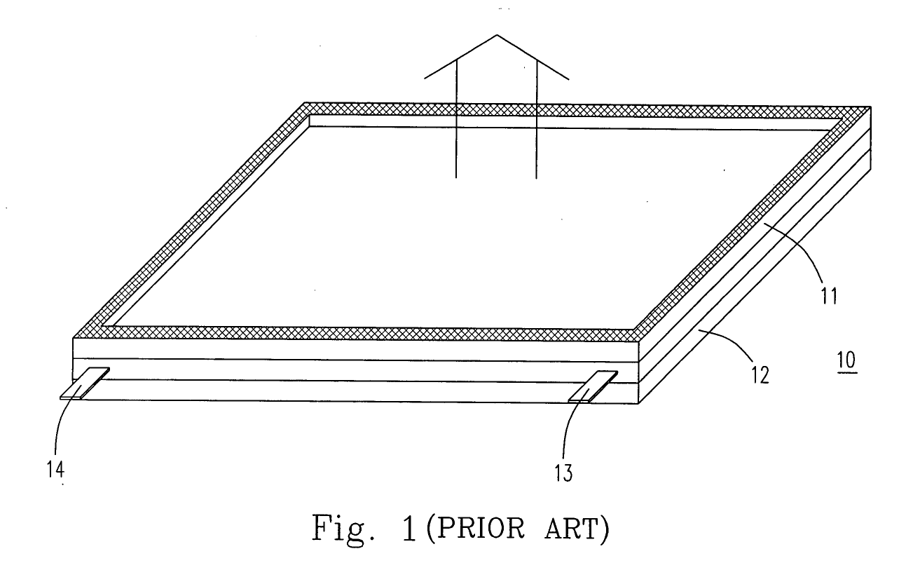

### DETAILED DESCRIPTION OF THE PREFERRED EMBODIMENT

The present invention will now described more specifically with reference to the following embodiments. In order to improve the disadvantages of conventional techniques, this invention provides a new electrode structure as shown in the following paragraphs.

Please refer to FIG. 4, which is a top view of the first embodiment of the electrode structure of the present invention showing auxiliary electrodes. As shown in FIG. 4, the electrode structure 40 of the present invention contains a first auxiliary electrode 411, a second auxiliary electrode 412, a first edge electrode 421, a second edge electrode 422 and a plurality of electrode pairs 43 or 44. The first edge electrode 421 has a same polarity as that of the first auxiliary electrode 411 to form an electrode pair, and the second edge electrode 422 has a same polarity as that of the second auxiliary electrode 412 to form an electrode pair. The electrode pair 43 or 44 is disposed between the first edge electrode 421 and the second edge electrode 422. Each electrode pair 43 or 44 is consisted of two electrodes having the same polarity to form a pair of electrodes. One electrode pair has a opposite polarity to that of an electrode pair adjacent to the electrode pair. For example, the electrode pair 43 shown in FIG. 4 is consisted of two electrodes 431 and 432 having the same polarity, and the electrode pair 44 is consisted of two electrodes 441 and 442 having the same polarity. But, the electrode pairs 43 and 44 have opposite polarities.

The main technical feature of the present invention concerns a design of the first edge electrode 421 and the second edge electrode 422. As described above, the cause of the dark zone of a flat fluorescence lamp is that no electrode having same polarity exists in the neighborhood of the edge electrodes 421 and 422 to form an electrode pair such that the electrical field and current density in the zone are weak. Therefore, the auxiliary electrodes 411 and 412 are respectively disposed at the outside of the first edge electrode 421 and the second edge electrode 422. Although the polarities of the auxiliary electrodes 411 and 412 are respectively the same as those of the first edge electrode 421 and the second edge electrode 422, the auxiliary electrodes 411 and 412 do not participate in gas discharging by the edge electrodes which respectively form electrode pairs. The main purpose of the auxiliary electrode is simply to enhance the electrical field and current density near its adjacent edge electrodes.

The first auxiliary electrode 411 does not participate in the gas discharging between the first edge electrode 421 and the electrode 441. The first auxiliary electrode 411 has the same polarity as that of the first edge electrode 421 and is used to enhance the electrical field and current density near the first edge electrode 421 such that the light brightness generated by the gas discharging between the first edge electrode 421 and the electrode 441 increases and such that the light brightness does not differ greatly from that generated by the gas discharging between the electrode pairs in the middle of the cold cathode flat fluorescence lamp. The same principle can be applied to the second auxiliary electrode 412 and the second edge electrode 422 at the other side.

Through the electrode structure shown in FIG. 4, the edge dark zone phenomenon of convention techniques can be improved if it is applied to the design of a cold cathode flat fluorescence lamp.

It is another technical feature of the present invention that the electrical field intensity and current density near the edge electrodes 421, 422 can be controlled and the light brightness in the edge zone of a cold cathode flat fluorescence lamp can be regulated by changing the widths of the auxiliary electrodes 411, 412 and by regulating the distance between the auxiliary electrodes 411, 412 and the edge electrodes 421, 422.

Please refer to FIG. 4 again. A first adjustable distance is made between the first auxiliary electrode 411 and the first edge electrode 421, and a second adjustable distance is made between the second auxiliary electrode 412 and the second edge electrode 422. Because the first adjustable distance is in reverse proportion to the brightness, if the first adjustable distance is increased and the width of the first auxiliary electrode 411 becomes smaller, the electrical field and current density near the first edge electrode 421 is decreased, thereby decreasing the brightness of the edge zone. On the contrary, if the first adjustable distance is decreased and the width of the first auxiliary electrode 411 becomes larger, the electrical field and current density near the first edge electrode 421 is increased, thereby increasing the brightness of the edge zone. The same principle can be applied to the second auxiliary electrode 412 and the second edge electrode 422 at the other side.

The way to increase the width of the edge electrode is demonstrated in FIG. 6. Without the addition of an auxiliary electrode, the widths of the edge electrodes 621 and 622 are increased to be 1.5-4 times of them in order to increase the current density in the edge discharging zone of the cold cathode flat fluorescence lamp. Therefore, the brightness near the ends of the lamp is increased. Certainly, the method can be implemented with the above method where an auxiliary electrode is added.

Another advantage of the above technique to regulate the brightness near the edge zone is that a plurality of the cold cathode flat fluorescence lamps having the electrode structure are combined to form a large scale cold cathode flat fluorescence lamp, the brightness near the edge interface can be controlled and a large scale flat fluorescence lamp having uniform brightness is obtained by regulating the brightness of the edge zone in each cold cathode flat fluorescence lamp.

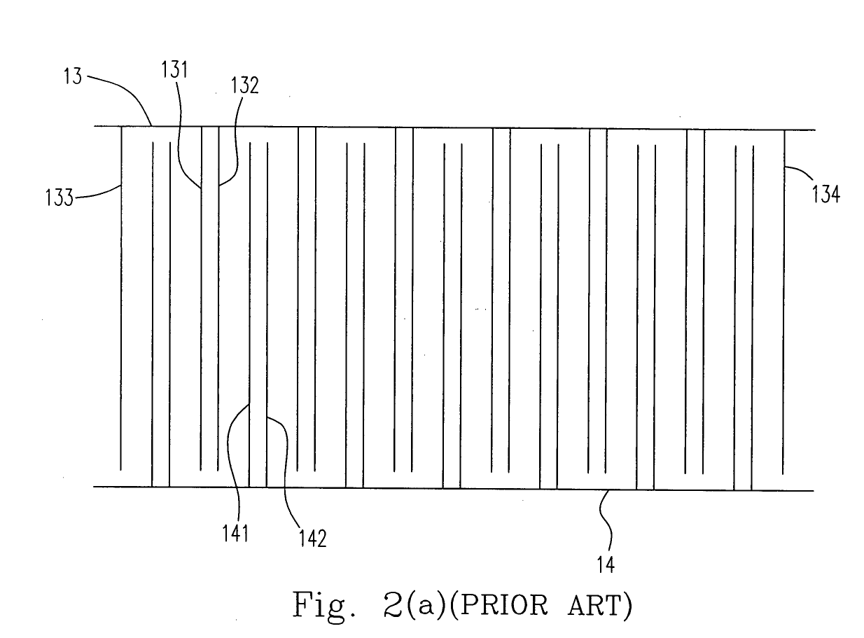

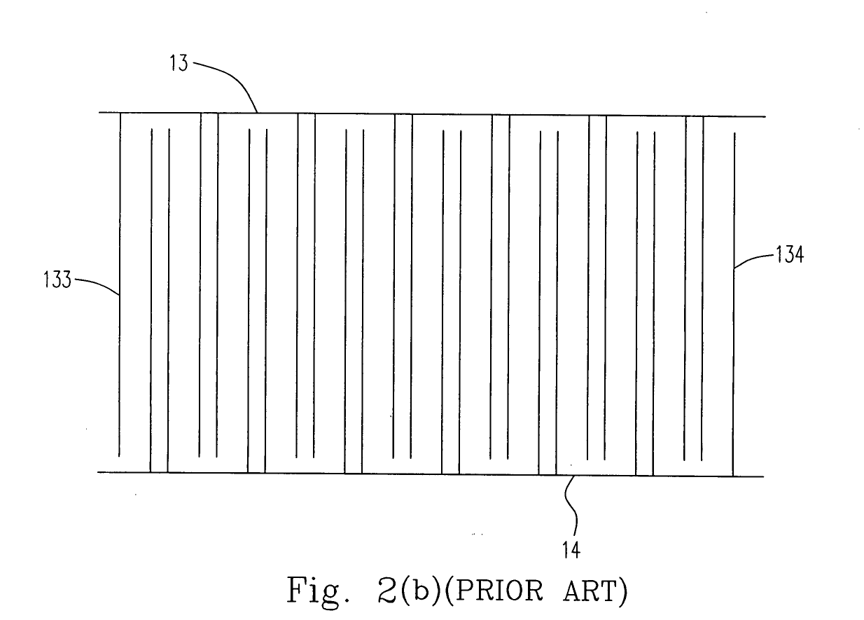

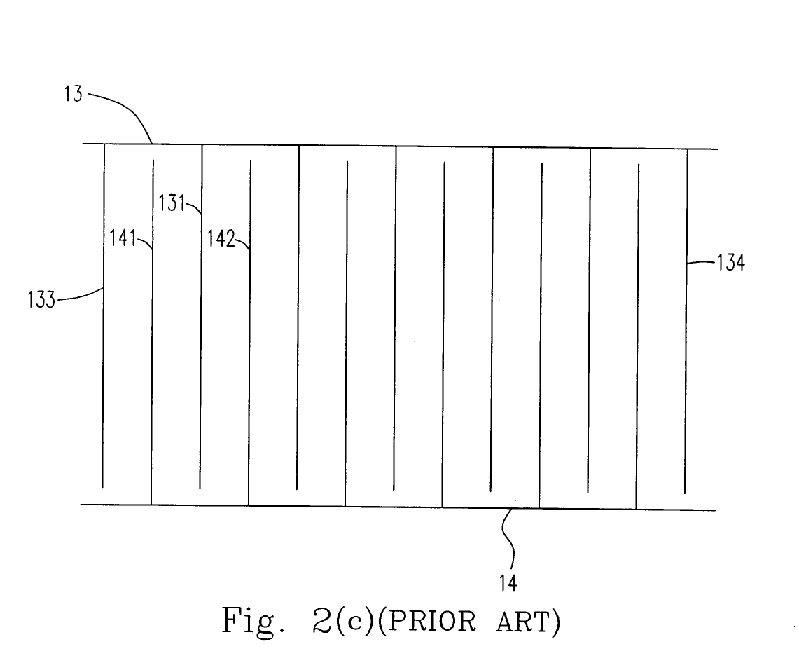

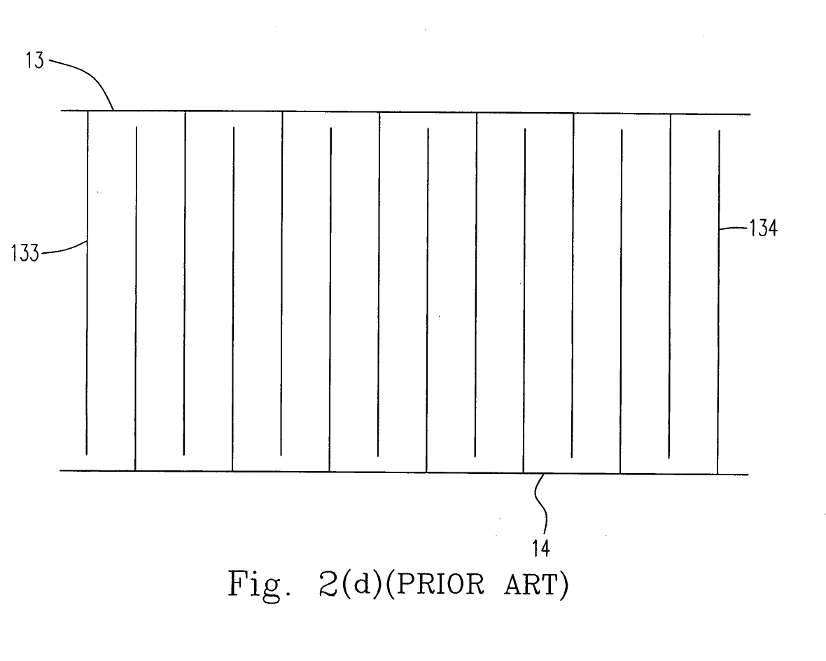

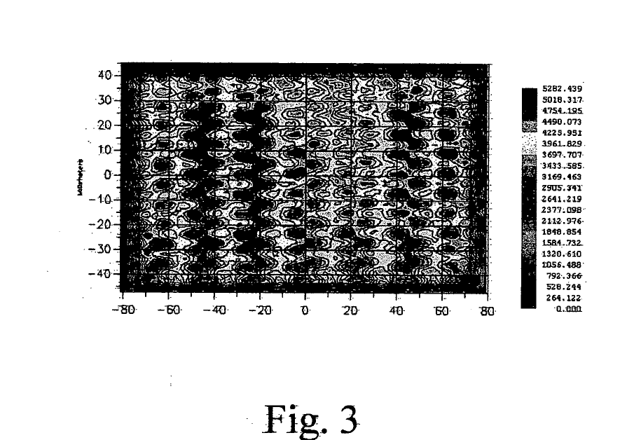

It shall be noted that the amount of the electrode pairs 43, 44, 64 shown in FIGS. 4 and 6 is odd, e.g. there exist thirteen electrode pairs in FIGS. 4 and 6. The first edge electrode 421 and the second edge electrode 422 have the same polarity. Alternatively the amount of the electrode pairs can be even, e.g. there exist twelve electrode pairs in FIG. 2(b). At this time, the two edge electrodes have opposite polarities, but the working principle is the same.

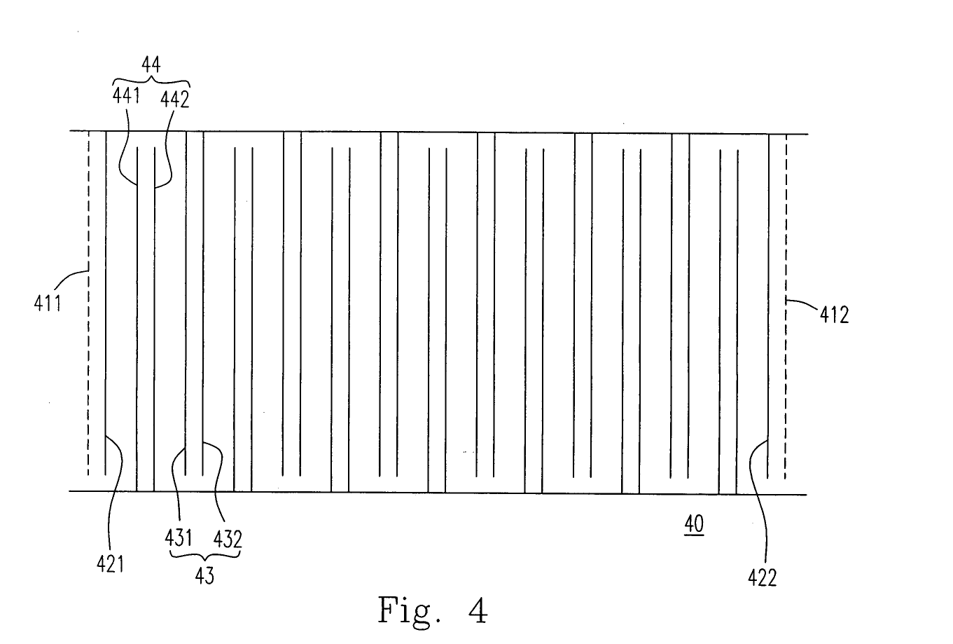

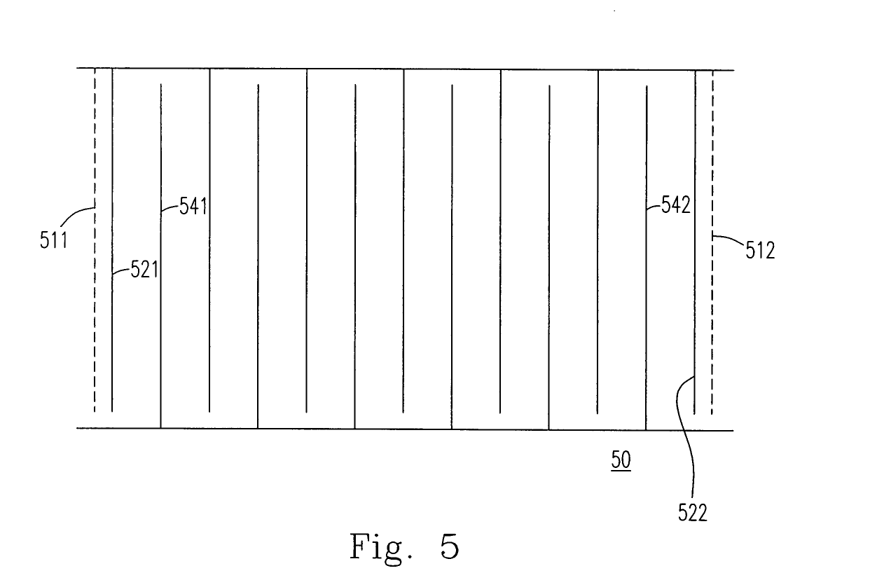

In the same way, the technique of manufacturing the electrode structure of the present invention can be applied to the electrode structures in FIGS. 2(c) and 2(d). The electrode structure in FIG. 2(c) is exemplified. The modified electrode structure is shown in FIG. 5. A first edge electrode 521 and a first auxiliary electrode 511 have a same polarity and form an electrode pair. A second edge electrode 522 and a second auxiliary electrode 512 have a same polarity and form an electrode pair. When the gas discharging is carried out, the first auxiliary electrode 511 increases the electrical field and current density near the first edge electrode 521 and enhances the gas discharging between the first edge electrode 521 and the electrode 541, while the second auxiliary electrode 512 increases the electrical field and current density near the second edge electrode 522 and enhances the gas discharging between the second edge electrode 522 and the electrode 542.

The electrode structure in which the width of an edge electrode becomes 1.5 times of its original value is applied to the electrode structures in FIG. 2(c) and FIG. 2(d). Similarly, the electrode structure shown in FIG. 2(c) is improved as the electrode structure shown in FIG. 7 where the widths of edge electrodes 721 and 722 becomes 1.5 times or more of their original values in order to increase the current density in the edge discharging zone and to increase the brightness near the ends.

Certainly, the above technique which two auxiliary electrodes are made of and have two opposite polarities and the adjustable distance between the edge electrode and the auxiliary electrode is regulated to enhance the brightness in the edge zone, can be applied to the electrode structures 50 and 70 in FIGS. 5 and 7. Because the principle is the same, the details are not repeated again.

In view of the middle electrodes between two edge electrodes, the electrode pairs shown in FIG. 4 and the single electrode shown in FIG. 5 can use the technique mentioned above to enhance the brightness near the ends. In the claims of the present invention the recitation “at least one middle electrodes disposed between the edge electrodes” are used as generalized wordings. In other words, it defines that an auxiliary electrode used for enhancing the electrical field is disposed at the location of a single edge electrode and another method is to increase the width of the edge electrode. Both methods are defined to be within the scope of the present invention.

It shall be noted that from FIGS. 2, 4, 5, 6 and 7, a salient or a recess having various shapes, such as a circle shape, a triangular shape, an arc shape, etc., can be used for the body of each single electrode and will not affect the normal operation of the electrode structure.

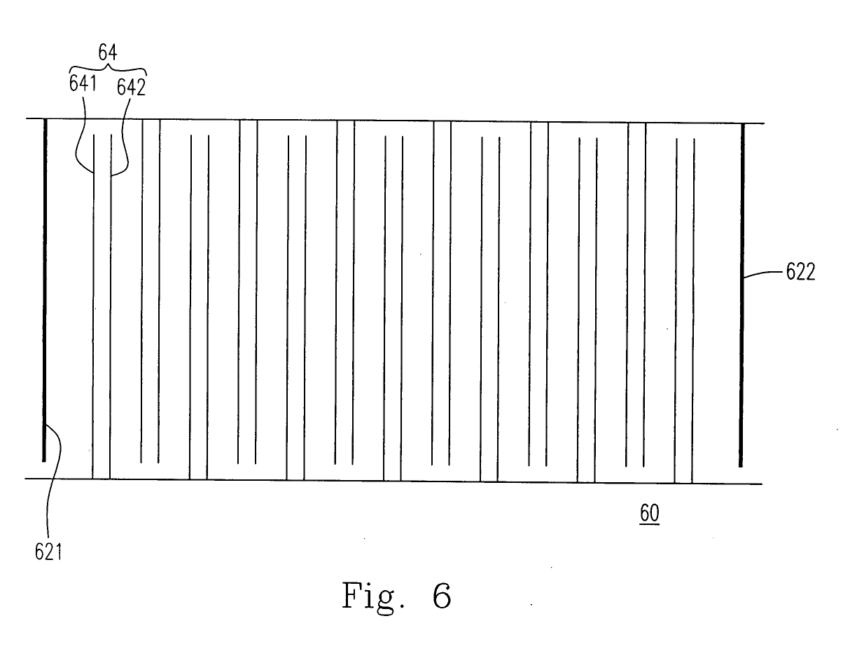

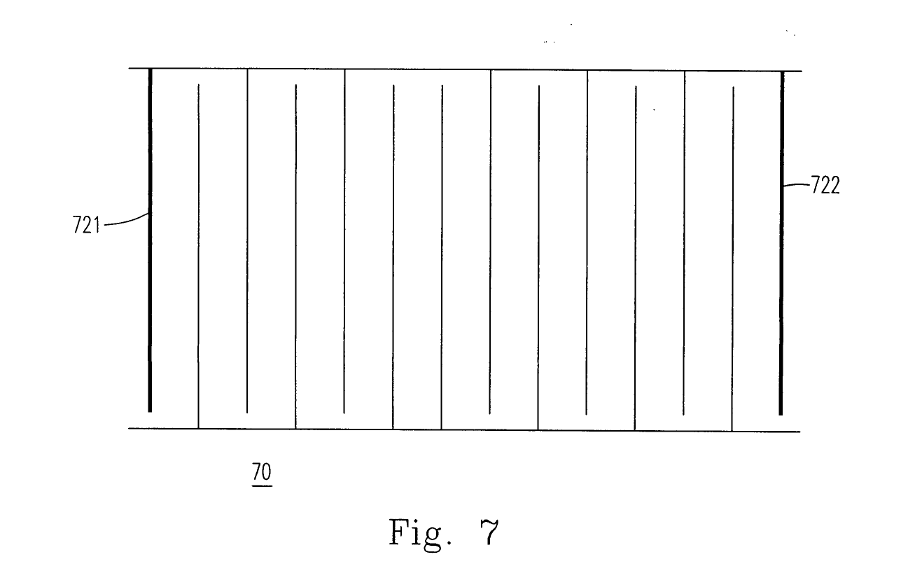

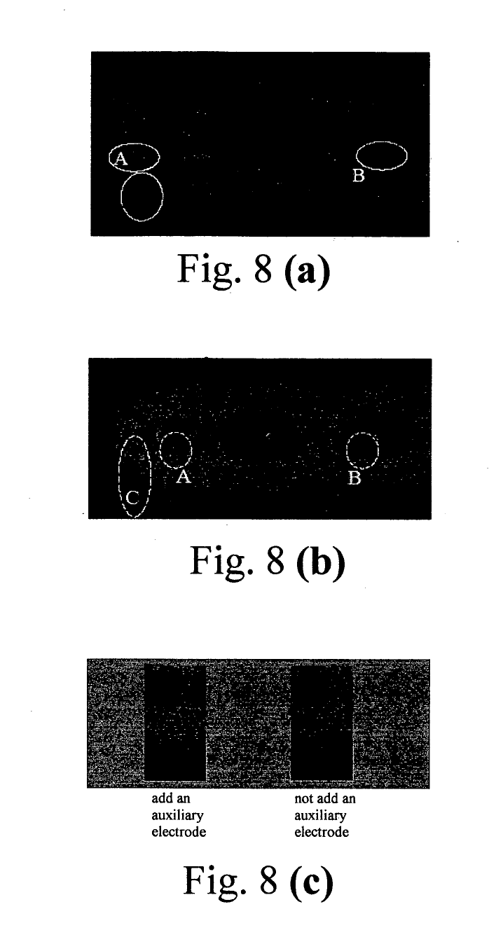

In order to prove that the electrode structure with an addition of the auxiliary electrode will affect the electrical field, the present inventor evaluated it by using an electrical simulation system. Please refer to FIGS. 8(a) and 8(b) which is respectively an electrical field simulation diagram with or without the addition of the auxiliary electrode. From the comparison drawing of FIG. (c), the electrical field is more uniform and complete after the auxiliary electrode is added and the inference recited in the paragraph of BACKGROUND OF THE INVENTION is confirmed.

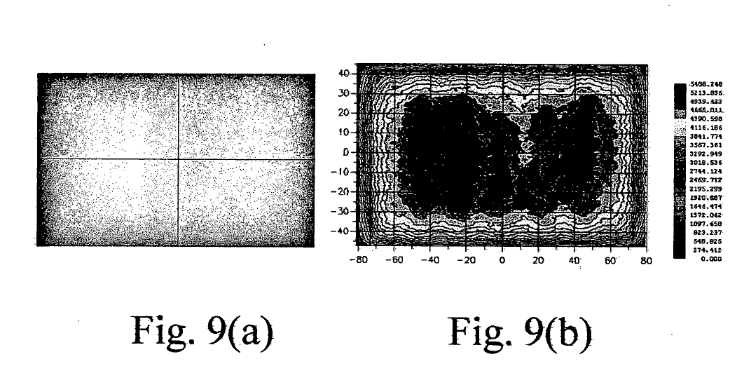

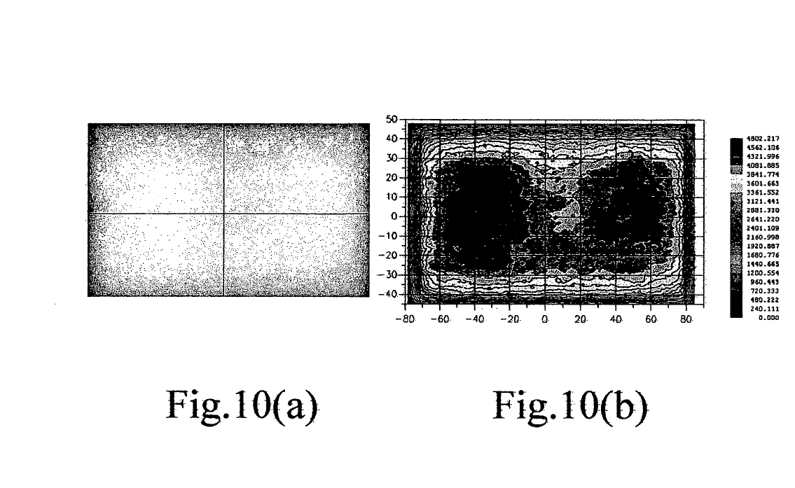

After the auxiliary electrode is added to increase the brightness at the discharging zone at the two ends, a diffuse and diffuser are mounted on the flat fluorescence lamp to observe whether the edge dark zone of the backlight modular is improved or not. The observation results are shown in FIGS. 9 and 10. FIGS. 10(a) and 10(b) are respectively a lighting status diagram with an addition of an auxiliary electrode and its brightness distribution diagram while FIGS. 9(a) and 9(b) are respectively a lighting status diagram without an addition of an auxiliary electrode and its brightness distribution diagram. From the comparison between the FIGS. 10(a) and 10(b) and the FIGS. 9(a) and 9(b) it is known that after the addition of an auxiliary electrode, the lighting zones obviously expand to left and right sides and the edge dark zone problem is improved greatly.

In summary, an auxiliary electrode with a same polarity is respectively disposed at the outside of the edge electrode at the two sides of the flat fluorescence lamp to obtain the electrode structure of the present invention. Alternatively, the width of the edge electrode increases to be 1.5-4 times of the original width in order to increase the electrical field and current density during gas discharging toward the edge electrode and to increase the brightness of the edge zone of the flat fluorescence lamp. Alternatively, the adjustable distance between the auxiliary electrode and the edge electrode is suitably regulated or the width of the edge electrode is changed to freely regulate the light brightness of the edge zone so that the product meets the demands of the customers. The plural flat fluorescence lamps having the electrode structure are combined to obtain a large scale cold cathode flat fluorescence lamp having homogeneous brightness.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended

What is claimed is:

1. An electrode structure comprising:
a first auxiliary electrode and a second auxiliary electrode; and
a first edge electrode and a second edge electrode disposed between the first auxiliary electrode and the second auxiliary electrode, wherein the first edge electrode and the first auxiliary electrode form a first electrode pair and have a first polarity, and the second edge electrode and the second auxiliary electrode form a second electrode pair and have a second polarity;
at least one middle electrode disposed between the first edge electrode and the second edge electrode;
wherein an interaction between the first edge electrode and the second edge electrode and a neighboring electrode thereof is enhanced by means of the first auxiliary electrode and the second auxiliary electrode.

2. The electrode structure according to claim 1, wherein a first adjustable distance exists between the first auxiliary electrode and the first edge electrode, and a second adjustable distance exists between the second auxiliary electrode and the second edge electrode.

3. The electrode structure according to claim 2, wherein the amounts of the first adjustable distance and the second adjustable distance determine a strength of the interaction.

4. The electrode structure according to claim 1, wherein the first edge electrode and the second edge electrode are located with a first electrode width which determines the strength of the interaction.

5. The electrode structure according to claim 4, wherein the first edge electrode and the second edge electrode are located with a second electrode width which is 1.5-4 times of the first electrode width.

6. The electrode structure according to claim 1, further comprising plural middle electrodes, the plural middle electrodes form a plurality of electrode pairs.

7. The electrode structure according to claim 6, wherein each of the plurality of electrode pairs is formed from two middle electrodes having a same polarity, and two adjacent electrode pairs have the opposite polarities.

8. The electrode structure according to claim 7, wherein when an amount of the electrode pairs is odd, the first edge electrode and the second edge electrode have the same polarity.

9. The electrode structure according to claim 7, wherein when an amount of the electrode pairs is even, the first edge electrode and the second edge electrode have an opposite polarity.

10. The electrode structure according to claim 6, wherein each of the plural middle electrodes is a single electrode, and adjacent middle electrodes thereof have opposite polarities.

11. A cold cathode flat fluorescent lamp comprising the electrode structure of claim 1.

12. The cold cathode flat fluorescent lamp according to claim 11, wherein the interaction is a gas discharging effect.

13. A large scale cold cathode flat fluorescent lamp comprising plural cold cathode flat fluorescent lamps of claim 11.
